(19) United States
(12) Patent Application Publication
(10) Pub. No.: US 2010/0205130 A1
(43) Pub. Date: Aug. 12, 2010

(54) ADAPTIVE TRANSIENT MULTI-NODE HEAT SOAK MODIFIER

(75) Inventor: C.E. Tapie Rohm, III, Greenville, SC (US)

Correspondence Address: CANTOR COLBURN, LLP, 20 Church Street, 22nd Floor, Hartford, CT, 06103, US

(73) Assignee: GENERAL ELECTRIC COMPANY, Schenectady, NY (US)

(21) Appl. No.: 12/369,908

(22) Filed: Feb. 12, 2009

(51) Int. Cl. G06N 3/02

(52) U.S. Cl. 706/21

(57) ABSTRACT

A method of adjusting parameters for one or more heat soak models for a system in a transient performance model, comprising: simulating the system in a transient prediction module; generating a first prediction of the system from the transient prediction module; generating a transfer function in response to the first prediction and a set of field data utilizing a neural network module; applying the transfer function from the neural network module to the transient prediction module; adjusting parameters of a first heat soak model for the system in the transient prediction module in response to the application of the transfer function to match with the set of field data; and generating a calculated modifier in response to the adjustment of parameters of the first heat soak model, the calculated modifier is a calculated difference between the first prediction and a second prediction as defined by the transfer function.

### BACKGROUND OF THE INVENTION

This invention relates generally to a control system based on a neural network for adjusting parameters of multiple heat soak models for a system in a transient performance model (TPM) in response to field data.

The current transient performance model is a 1D quasi-steady state prediction tool that models startups and shutdowns. To do this properly the tool has a heat soak model in two locations, for example, the end of the compressor and the end of the turbine. These two lumped nodes are based on a convective heat transfer model that predicts energy transfer between the flow path and the metal mass of the rotor and casing. The issue is that on shutdowns the models do not properly transfer heat back to the flow stream. While it is acknowledged that this can be fixed by improving the physics to include things like radiation and the use of more nodes rather than just two nodes. However, there is a development cost of changing all the code to handle this.

The problem as defined above is simply that on shutdowns the predictions start to severely underestimate the exhaust temperature and the compressor discharge temperature. This is based on the fact that the heat soak does not take into account radiation, nor are there enough nodes, nor does the heat of the rotor in the turbine have any influence on the compressor in the prediction tool software. In other words, for transient performance simulation, the transient performance model does not properly capture the heat soak affects as experienced in the gas turbine. To account for this current problem, engineers have to adjust the output parameters of the transient performance model and tune them to field data. This is done for each specific site and analysis where a shutdown analysis is performed. This can take up to several days in changes and adjustment as well as introduce the possibility of error into the process.

Accordingly, it is desirable to adjust parameters of multiple heat soaks for a system in a transient performance model based on field data utilizing a neural network system.

### BRIEF DESCRIPTION OF THE INVENTION

According to one aspect of the invention, a method of adjusting parameters for one or more heat soak models for a system in a transient performance model is provided. The method includes simulating the system in a transient prediction module; generating a first predicted output of the system from the transient prediction module; generating a transfer function in response to the first predicted output and a set of field data utilizing a neural network module; applying the transfer function from the neural network module to the transient prediction module; adjusting parameters of a first heat soak model for the system in the transient prediction module in response to the application of the transfer function to match with the set of field data; and generating a calculated modifier in response to the adjustment of parameters of the first heat soak model, the calculated modifier is a calculated difference between the first predicted output and a second predicted output as defined by the transfer function from the neural network.

According to another aspect of the invention, a control system for adjusting parameters of one or more heat soak models of a system in a simulation model is provided. The control system includes a transient prediction module configured to simulate the system and generate a first predicted output of the system; and a neural network module integrated with the transient prediction module, the neural network module configured to generate a transfer function in response to the first predicted output and a set of field data, the neural network module further configured to apply the transfer function to the transient prediction module and adjust parameters of a first heat soak model for a heat soak of the system in response to the application of the transfer function to match with the set of field data, the neural network module generates a calculated modifier in response to the adjustment of parameters of the first heat soak model, the calculated modifier is a calculated different between the first predicted output and a second predicted output as defined by the transfer function from the neural network.

According to yet another aspect of the invention, a control system for adjusting parameters of one or more heat soak models for a system in a transient performance model is provided. The system comprises a computer readable medium having a computer program configured to simulate the system in a transient prediction module; generate a first predicted output of the system from the transient prediction module; generate a transfer function in response to the first predicted output and a set of field data utilizing a neural network module; apply the transfer function from the neural network module to the transient prediction module; adjust parameters of a first heat soak model of the system in response to the application of the transfer function to match with the set of field data; and generate a calculated modifier in response to the adjustment of parameters of the first heat soak model, wherein the calculated modifier is a calculated difference between the first predicted output and a second predicted output as defined by the transfer function from the neural network.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a computing system of a control system in accordance with one exemplary embodiment of the present invention;

FIG. 2 is a block diagram of programs installed in the computing system in accordance with one exemplary embodiment of the present invention;

FIG. 3 is block diagram of a system modeled by the computing system in accordance with one exemplary embodiment; and

FIG. 4 is a flow diagram that provides a method for adjusting parameters of one or more heat soak models for a system in a transient performance model in accordance with one exemplary embodiment.

The detailed description explains embodiments of the invention, together with advantages and features, by way of example with reference to the drawings.

### DETAILED DESCRIPTION OF THE INVENTION

Exemplary embodiments are directed to a control system for adjusting parameters of multiple heat soaks for a system in a detailed transient model (TPM) based on field data utilizing a neural network. These exemplary embodiments properly capture the heat soak affects as experienced in the actual system in a TPM. Exemplary embodiments are also directed to a method for automatically adjusting parameters of multiple heat soaks for a system in a TPM to match a given field data utilizing a neural network. Further, in these embodiments, the method includes generating a calculated modifier that can be used as a gauge as to the accuracy or quality of the TPM program.

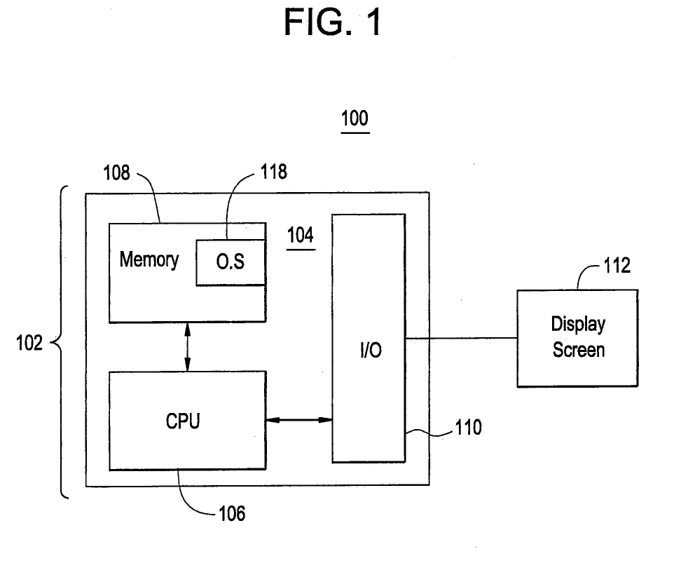

Now referring to the drawings, FIG. 1 illustrates a computing system 100 that includes a control system in accordance with one exemplary embodiment of the present invention. The computing system 100 is shown to include a computer 102. The computer 102 is configured to support detailed transient model (TPM) applications and other computer applications/programs for carrying out the methods described herein. In accordance with one exemplary embodiment, the computer 102 described herein is configured to integrate other applications (e.g., neural network applications) with TPM applications such that parameters of multiple heat soaks for a system in a TPM can be adjusted to match field data.

The computer 102 includes a controller 104 having a central processing unit (CPU) 106, a memory 108, which includes a read-only memory (ROM) and a volatile memory such as a random access memory (RAM) in accordance with one exemplary embodiment. The controller 104 further includes an input/output (I/O) interface 110, which is in signal communication with a display screen 112. The I/O interface 110 can also be in signal communication to other systems (e.g., sensors) for receiving field data. As can be appreciated, the computing system 102 can include any computing device, including but not limited to, a desktop computer, a laptop, a server, a portable hand held device (e.g., personal digital assistant (PDA)) or otherwise. For ease of discussion, exemplary embodiments will be discussed in the context of a computer.

The CPU 106 operably communicates with the memory 108 and I/O interface 110. The computer readable media including memory 108 may be implemented using any of a number of known devices such as PROMs, EPROMs, and EEPROMs, flash memory or any other electric, magnetic, optical or combination memory device capable of storing data, some of which represent executable instructions used by CPU 106.

When the computer 102 is in operation, the CPU 106 is configured to execute instructions by fetching instructions within memory 108 to generally control operations of the computer 102 pursuant to the instructions. In one exemplary embodiment, the memory 106 includes a suitable operating system (OS) 118. The operating system 118 is configured to control the execution of the computer programs (e.g., TPM application) installed in the memory 108 and provide input-output control, memory management, and communication control and related services. The CPU 106 can be any conventional processing unit configured for carrying out the methods and/or functions described herein. In one exemplary embodiment, the CPU 106 comprises a combination of hardware and/or software/firmware with a computer program that, when loaded and executed, permits the CPU 106 to operate such that it carries out the methods described herein.

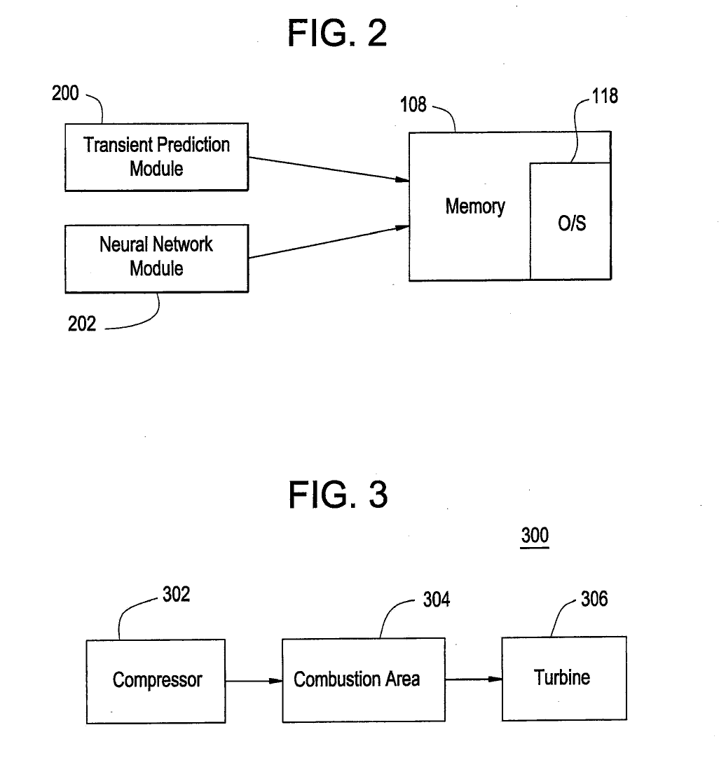

FIG. 2 illustrates a block diagram of the programs or applications installed in computer 102 for carrying out the methods described herein. In accordance with one exemplary embodiment, a TPM application, which is indicated as a transient prediction module 200, is installed into memory 108. The transient prediction module 200 is configured to model or automate operations (e.g., startups and shutdowns) of a system through its heat soak models of heat soaks of the system. During a transient performance simulation, the transient prediction module 200 generates a predicted output of state parameters relating to the system. In accordance with one non-limiting exemplary embodiment, the system is a gas turbine as illustrated in FIG. 3. Of course, other known systems can be modeled to generate a predicted output of the same through the transient prediction module 200 and should not be limited to the configuration described herein. For ease of discussion, a gas turbine 300 as illustrated in FIG. 3 will be discussed in greater detail.

FIG. 3 illustrates the basic elements of the gas turbine 300 in accordance with one exemplary embodiment. The gas turbine 300 generally includes a compressor 302, a combustion area 304, and a turbine 306. In general, air received by the compressor 302 is forced through a compression stage, which significantly raises its pressure. The high-pressure air enters the combustion area 304 and is mixed with fuel, for example gas and/or synthetic gas, and then ignited by an igniting mechanism (e.g., spark plug) to form a high pressure, high temperature combustion gas stream. The turbine 306 extracts the energy from the high-pressure, high velocity gas flowing from the combustion chamber. The gas turbine can have varying configurations and should not be limited to the configuration shown in FIG. 3.

In accordance with one exemplary embodiment, the transient prediction module 200 has multiple heat soak models of multiple heat soaks that exist at different places of the gas turbine 300. In accordance with one embodiment, the transient prediction module 200 is configured to model the startups and shutdowns of the gas turbine 300 when operated. The transient prediction module 200 has multiple heat soak models of heat soaks in the gas turbine 300 to generate a predicted output of the gas turbine 300. In accordance with one exemplary embodiment, the predicted output comprises of the compressor exit temperature and/or the exhaust temperature. Of course other state parameters can be provided in the predicted output and should not be limited to the ones described herein.

In accordance with one exemplary embodiment, the transient prediction module 200 has a first heat soak model for the output of the compressor and a second heat soak model for the output of the turbine. Of course, the transient prediction module 200 can have multiple heat soak models of heat soaks in multiple locations of the gas turbine and should not be limited to the number and configuration described herein. In accordance with one exemplary embodiment, the first heat soak model is representative of a heat soak located in a first location of the gas turbine while the second heat soak model is representative of another heat soak located in a second location of the gas turbine. In accordance with one embodiment, the first heat soak model enables the estimation or prediction of the compressor exit temperature of the compressor while the second heat soak model enables the estimation or prediction of the exhaust temperature of the turbine in accordance with one exemplary embodiment. The transient prediction module 200 is generally based on conventional engineering physics as well as engineering laws and equations and its heat soak models are based on simplified scaled convention models to provide a predicted output of the system. Thus, the heat soak models of the transient prediction module 200 do not predict gas turbine behavior as defined from field data for the compressor and the turbine.

Referring back to FIG. 2, a neural network application, which is indicated as a neural network module 202, is installed into memory 108 in accordance with one exemplary embodiment. The neural network module 202 is configured to receive the predicted output generated from the transient prediction module 200 as well as field/sensor data from a test site to generate a transfer function used to adjust the parameters of the heat soak models and tune them to field data, which is based on real data in accordance with one exemplary embodiment.

In accordance with one exemplary embodiment, field data for the components of the gas turbine 300, such as the compressor 302 and the turbine 306 can be taken from a test site. In accordance with one exemplary embodiment, field data is a set of direct measurements taken on the actual gas turbine of interest. These direct measurements provide state conditions like temperature, pressure, location in gas turbine, and time to the neural network module 202 to properly predict a components or systems output. These measurements capture the affects of conduction, convention, radiation and the like. One or more various sensor types (e.g., contact temperature sensors) can be used to take these various measurements.

In accordance with one exemplary embodiment, the neural network module 202 generates the transfer function in time domain to apply to the transient prediction module 200. The transient predication module 200 can run its normal prediction function or routine and then run the transfer function with the predicted output to generate a calculated modifier. In other words, the transient prediction module 200 is configured to run without the transfer function to generate the predicted output and then run with the transfer function to generate a calculated modifier that can be used to improve the predicted output in accordance with one exemplary embodiment. Of course, it is contemplated that the transient prediction module 200 is configured to simultaneously generate both the predicted output and the calculated modifier from the transient prediction module 200 in accordance with other exemplary embodiments.

In operation, when the transfer function is applied to the transient prediction module 200, the parameters of the multiple heat soak models are adjusted based on the field data to provide the calculated modifier and improve the predicted output answer. In accordance with one exemplary embodiment, the transfer function is applied to the transient prediction module 200 to adjust the parameters of the first heat soak model and then adjust the parameters of the second heat soak model. In accordance with this embodiment, the parameters of the first heat soak model are adjusted before the parameters of the second heat soak model since the adjustment of the parameters of the second heat soak model can be affected by the output of the first heat soak model. For example, the parameters of the first heat soak model for the compressor are adjusted based on field data providing for an improved compressor exit temperature. Then, the parameters of the second heat soak model for the turbine are adjusted based on field data providing for an improved exhaust temperature. However, the compressor exit temperature can influence the exhaust temperature. Thus, the parameters of the first heat soak model are adjusted before the parameters of the second heat soak model in accordance with one exemplary embodiment.

In accordance with one exemplary embodiment, the calculated modifier is the difference between the predicated output and another predicted output as defined by the field data. Thus, the calculated modifier can be used to modify the predicted output from the transient prediction module 200. In other words, the calculated modifier is simply the difference between the predicted output and what the predicted output would be based on field data. Therefore, the calculated modifier can be used as a gauge as to the quality and accuracy of the transient prediction module 200.

Since the neural network module 202 is trained on field data and not predictive data, as the prediction (predicted output) gets better over time due to code improvements in the transient prediction module 200, the calculated modifier eventually becomes less and less thus reducing software support for the transient prediction module 200. As such, the transient prediction module 200 keeps its physics and foundations and is adjusted based on field experience automatically for given states. Therefore, as the software program of the transient prediction module 200 improves with better physics, the neural network function will automatically provide a reduced delta or modifier.

By adjusting the heat soak parameters and not simply the output of the transient prediction module 200, the program remains generic for a wide class of engines or systems. As the transient prediction module 200 improves, the calculated modifier should decrease over time without having to recode the software to account for the improved engineering physics.

In accordance with one exemplary embodiment, the neural network module 202 can be any conventional neural network software application configured to simulate, develop and apply transfer functions that comprise of artificial neural networks matrices of equations that are based generally on the concept of self-learning. Thus, the neural network module 202 can improve its transfer function over time given more sensor/field data or prediction data. In accordance with one exemplary embodiment, the neural network module 202 can automatically adapt based on more field data as it comes in.

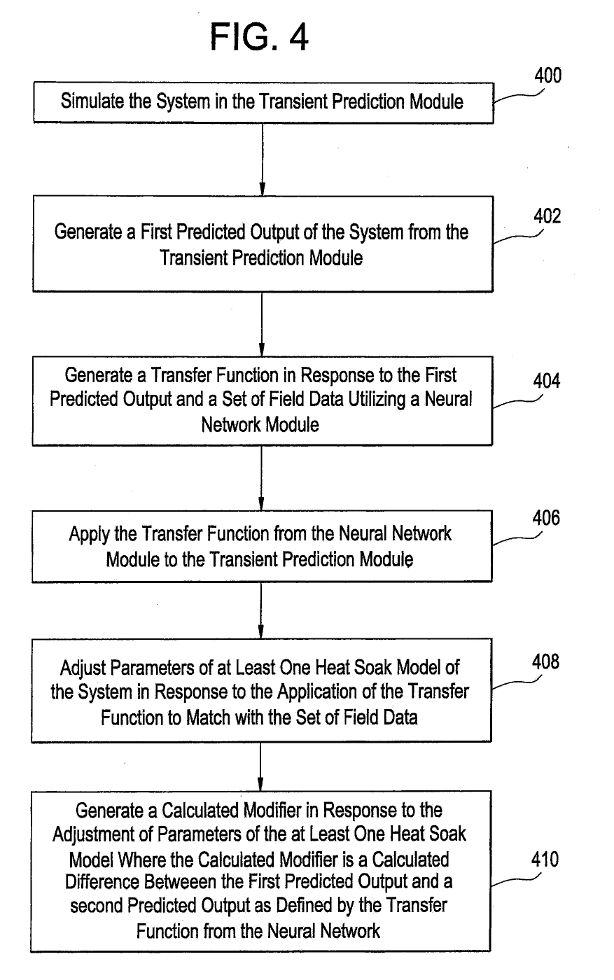

Now referring to FIG. 4, a method for adjusting parameters of one or more heat soak model for a system in a detailed transient model in response to field data in accordance with one exemplary embodiment will now be discussed.

At block 400, simulate the system in the transient prediction module 200. In accordance with one exemplary embodiment, the system is the gas turbine 300 as described above and is simulated through heat soak models of the transient prediction module 200 in accordance with one exemplary embodiment.

At block 402, generate a first predicted output of the system from the transient prediction module 200. The first predicted output can comprise of state parameters relating to the gas turbine 300, such as, for example, the compressor exit temperature and/or the exhaust temperature.

At block 404, generate a transfer function in response to the first predicted output and a set of field data utilizing a neural network module 202. The field data can be direct measurements on the actual gas turbine 300 in accordance with one exemplary embodiment.

At block 406, apply the transfer function from the neural network module 202 to the transient prediction module 200.

At block 408, adjust parameters of a first heat soak model for the system in the transient prediction module 200 in response to the application of the transfer function to match with the set of field data.

At block 410, generate a calculated modifier in response to the adjustment of parameters of the first heat soak model where the calculated modifier is a calculated difference between the first predicted output and a second predicted output as defined by the transfer function from the neural network. The second predicted output is determined by the transient prediction module 200 when the parameters of the first heat soak model in the transient prediction module 200 are adjusted in response to the application of the transfer function from the neural network module 202 in accordance with one exemplary embodiment.

In exemplary embodiments, the automatic adjustment to the heat soak parameters will eliminate the required code changes to the software prediction tool. Exemplary embodiments enable the TPM to better model shutdowns that match field data. Exemplary embodiments further enable the TPM to properly capture the heat soak affects as experienced in the gas turbine during transient performance simulation. As such, actual gas turbines that experience conduction, convection and radiation affects are properly captured in the simulation model.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method of adjusting parameters for one or more heat soak models for a system in a transient performance model, comprising:
simulating the system in a transient prediction module;
generating a first predicted output of the system from the transient prediction module;
generating a transfer function in response to the first predicted output and a set of field data utilizing a neural network module;
applying the transfer function from the neural network module to the transient prediction module;
adjusting parameters of a first heat soak model for the system in the transient prediction module in response to the application of the transfer function to match with the set of field data; and
generating a calculated modifier in response to the adjustment of parameters of the first heat soak model, the calculated modifier is a calculated difference between the first predicted output and a second predicted output as defined by the transfer function from the neural network.

2. The method as in claim 1, wherein the system is a gas turbine.

3. The method as in claim 2, wherein the first predicted output comprises of at least one state parameter of the system.

4. The method as in claim 3, wherein the at least one state parameter is a compressor exit temperature, an exhaust temperature of the gas turbine or both.

5. The method as in claim 1, further comprising adjusting parameters of a second heat soak model for the system in the transient prediction module in response to the application of the transfer function.

6. The method as in claim 5, further comprising adjusting parameters of the first heat soak model before adjusting parameters of the second heat soak model.

7. The method as in claim 1, wherein the set of field data are actual measurements of the system.

8. The method as in claim 1, further comprising collecting the set of field data by utilizing one or more sensors.

9. The method as in claim 1, wherein the calculated modifier is generated from the transient prediction module.

10. The method as in claim 1, wherein the first heat soak model is representative of a heat soak in a first location of the system.

11. A control system for adjusting parameters of one or more heat soak models for a system in a transient performance model, comprising:
a transient prediction module configured to simulate the system and generate a first predicted output of the system; and
a neural network module integrated with the transient prediction module, the neural network module configured to generate a transfer function in response to the first predicted output and a set of field data, the neural network module further configured to apply the transfer function to the transient prediction module and adjust parameters of a first heat soak model for a heat soak of the system in response to the application of the transfer function to match with the set of field data, the neural network module generates a calculated modifier in response to the adjustment of parameters of the first heat soak model, the calculated modifier is a calculated different between the first predicted output and a second predicted output as defined by the transfer function from the neural network.

12. The control system as in claim 11, wherein the system is a gas turbine.

13. The control system as in claim 12, wherein the first predicted output comprises of at least a compressor exit temperature, an exhaust temperature of the gas turbine, or both.

14. The control system as in claim 11, wherein the neural network module is further configured to adjust parameters of a second heat soak model for another heat soak of system in the transient prediction module in response to the application of the transfer function.

15. The control system as in claim 14, wherein parameters of the first heat soak model are adjusted before parameters of the second heat soak model.

16. The control system as in claim 14, wherein the first heat soak model is representative of a heat soak in a first location of the system and the second heat soak model is representative of another heat soak in a second location of the system.

17. The control system as in claim 11, wherein the set of field data are actual measurements of the system taken by one or more sensors.

18. The control system as in claim 11, wherein the calculated modifier is generated from the transient prediction module.

19. A control system for adjusting parameters of one or more heat soak models for a system in a detailed transient model, the control system comprising:
a computer readable medium having a computer program configured to simulate the system in a transient prediction module; generate a first predicted output of the system from the transient prediction module; generate a transfer function in response to the first predicted output and a set of field data utilizing a neural network module; apply the transfer function from the neural network module to the transient prediction module; adjust parameters of a first heat soak model of the system in response to the application of the transfer function to match with the set of field data; and generate a calculated modifier in response to the adjustment of parameters of the first heat soak model, wherein the calculated modifier is a calculated difference between the first predicted output and a second predicted output as defined by the transfer function from the neural network.

20. The control system as in claim 19, wherein the computer program is further configured to adjust parameters of a second heat soak model for the system in the transient prediction module in response to the application of the transfer function.
